(19) United States
(12) Patent Application Publication
(10) Pub. No.: US 2020/0357138 A1
(43) Pub. Date: Nov. 12, 2020

(54) Vehicle-Mounted Camera Self-Calibration Method and Apparatus, and Storage Medium

(71) Applicant: Shanghai SenseTime Intelligent Technology Co., Ltd., Shanghai (CN)

(72) Inventors: Jie Xiang, Shanghai (CN); Ningyuan Mao, Shanghai (CN); Haibo Zhu, Shanghai (CN)

(73) Assignee: Shanghai SenseTime Intelligent Technology Co., Ltd., Shanghai (CN)

(21) Appl. No.: 16/942,965

(22) Filed: Jul. 30, 2020

Related U.S. Application Data
(63) Continuation of application No. PCT/CN2019/089033, filed on May 29, 2019.

(30) Foreign Application Priority Data
Jun. 5, 2018 (CN) 201810578736.5

(51) Int. Cl. G06T 7/80; H04N 5/225; G06T 7/73; G06K 9/00; H04N 17/00; B60R 11/04

(52) U.S. Cl. CPC G06T 7/80; H04N 5/2253; G06T 7/73; G06K 9/00798; H04N 17/002; B60R 2300/804; G06T 2207/30256; G06T 2207/30244; B60R 2300/101; B60R 2300/605; B60R 2300/402; B60R 11/04

(57) ABSTRACT

The present disclosure relates to a vehicle-mounted camera self-calibration method and apparatus, and a vehicle driving method and apparatus. The method comprises: starting self-calibration of a vehicle-mounted camera to enable a vehicle on which the vehicle-mounted camera is mounted to be in a traveling state; acquiring, by the vehicle-mounted camera in a traveling process of the vehicle, information required for self-calibration of the vehicle-mounted camera; and self-calibrating the vehicle-mounted camera based on the acquired information.

The present application claims priority to Chinese Patent Application No. 201810578736.5, filed with the Chinese Patent Office on Jun. 5, 2018, and entitled “VEHICLE-MOUNTED CAMERA SELF-CALIBRATION METHOD AND APPARATUS, AND VEHICLE DRIVING METHOD AND APPARATUS”, which is incorporated herein by reference in its entirety.

### TECHNICAL FIELD

The present disclosure relates to the technical field of image processing, and particularly to a vehicle-mounted camera self-calibration method and apparatus, and a vehicle driving method and apparatus.

### BACKGROUND

In conventional vehicle-mounted camera calibration methods, calibration needs to be performed on a specific reference object manually under a set camera model, then images are processed, calculation and optimization are carried out using a series of mathematical transformation formulas, and finally the camera is calibrated after a camera model parameter is obtained.

### SUMMARY

The present disclosure provides a vehicle-mounted camera self-calibration technical solution.

According to one aspect of the present disclosure, provided is a vehicle-mounted camera self-calibration method, including: starting self-calibration of a vehicle-mounted camera to enable a vehicle on which the vehicle-mounted camera is mounted to be in a traveling state; acquiring, by the vehicle-mounted camera in a traveling process of the vehicle, information required for self-calibration of the vehicle-mounted camera; and self-calibrating the vehicle-mounted camera based on the acquired information.

According to one aspect of the present disclosure, provided is a vehicle-mounted camera self-calibration apparatus, including: a self-calibration starting module, configured to start self-calibration of a vehicle-mounted camera to enable a vehicle on which the vehicle-mounted camera is mounted to be in a traveling state; an information acquisition module, configured to acquire, by the vehicle-mounted camera in a traveling process of the vehicle, information required for self-calibration of the vehicle-mounted camera; and a self-calibration operation module, configured to self-calibrate the vehicle-mounted camera based on the acquired information.

According to one aspect of the present disclosure, provided is a vehicle driving apparatus, configured to perform vehicle driving using the self-calibrated vehicle-mounted camera according to any one of the vehicle-mounted camera self-calibration methods above.

According to one aspect of the present disclosure, provided is an electronic device, including: a processor; and a memory configured to store processor-executable instructions; where the processor is configured to execute the foregoing methods.

According to one aspect of the present disclosure, provided is a computer readable storage medium, having computer program instructions stored thereon, where when the computer program instructions are executed by a processor, the vehicle-mounted camera self-calibration method is implemented.

According to one aspect of the present disclosure, provided is a computer program, including computer readable codes, where when the computer readable codes run in an electronic device, a processor in an electronic device executes instructions for implementing the vehicle-mounted camera self-calibration method.

In embodiments of the present disclosure, when self-calibration of a vehicle-mounted camera is started, the vehicle-mounted camera may be self-calibrated according to information acquired by the vehicle-mounted camera in a traveling process of the vehicle. The self-calibration process of the vehicle-mounted camera is able to be conveniently completed in an actual application environment of vehicle-mounted cameras without affecting use of vehicles, calibration results are accurate, the calibration efficiency is high, and the embodiments have a wide application range.

The other features and aspects of the present disclosure can be described more clearly according to the detailed descriptions of the exemplary embodiments in the accompanying drawings below.

### BRIEF DESCRIPTION OF THE DRAWINGS

The accompanying drawings included in the specification and constituting a part of the specification illustrate the exemplary embodiments, features, and aspects of the present disclosure together with the specification, and are used for explaining the principles of the present disclosure.

FIG. 1 is a flowchart illustrating a vehicle-mounted camera self-calibration method according to embodiments of the present disclosure;

FIG. 2 is a flowchart illustrating a vehicle-mounted camera self-calibration method according to embodiments of the present disclosure;

FIG. 3 is a flowchart illustrating a vehicle-mounted camera self-calibration method according to embodiments of the present disclosure;

FIG. 4 is a flowchart illustrating a vehicle-mounted camera self-calibration method according to embodiments of the present disclosure;

FIG. 5 is a schematic diagram illustrating points of intersection in a vehicle-mounted camera self-calibration method according to embodiments of the present disclosure;

FIG. 6 is a schematic diagram illustrating a horizon line in a vehicle-mounted camera self-calibration method according to embodiments of the present disclosure;

FIG. 7 is a schematic diagram illustrating key points in a vehicle-mounted camera self-calibration method according to embodiments of the present disclosure;

FIG. 8 is a block diagram illustrating a vehicle-mounted camera self-calibration apparatus according to embodiments of the present disclosure;

FIG. 9 is a block diagram illustrating an electronic device according to exemplary embodiments of the present disclosure.

### DETAILED DESCRIPTION

Various exemplary embodiments, features, and aspects of the present disclosure are described below in detail with reference to the accompanying drawings. The same reference numerals in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

In addition, numerous details are given in the following detailed description for the purpose of better explaining the present disclosure. It should be understood by persons skilled in the art that the present disclosure may still be implemented even without some of those details. In some examples, methods, means, elements, and circuits that are well known to persons skilled in the art are not described in detail so that the principle of the present disclosure becomes apparent. The following specific embodiments may be combined with each other, and the same or similar concepts or processes may not be described in some embodiments. It can be understood that the following embodiments are merely optional implementations in the present disclosure, and should not be constructed as limiting the scope of protection of the present disclosure. Persons skilled in the art may employ other implementations on this basis, which all fall within the scope of range of the present disclosure.

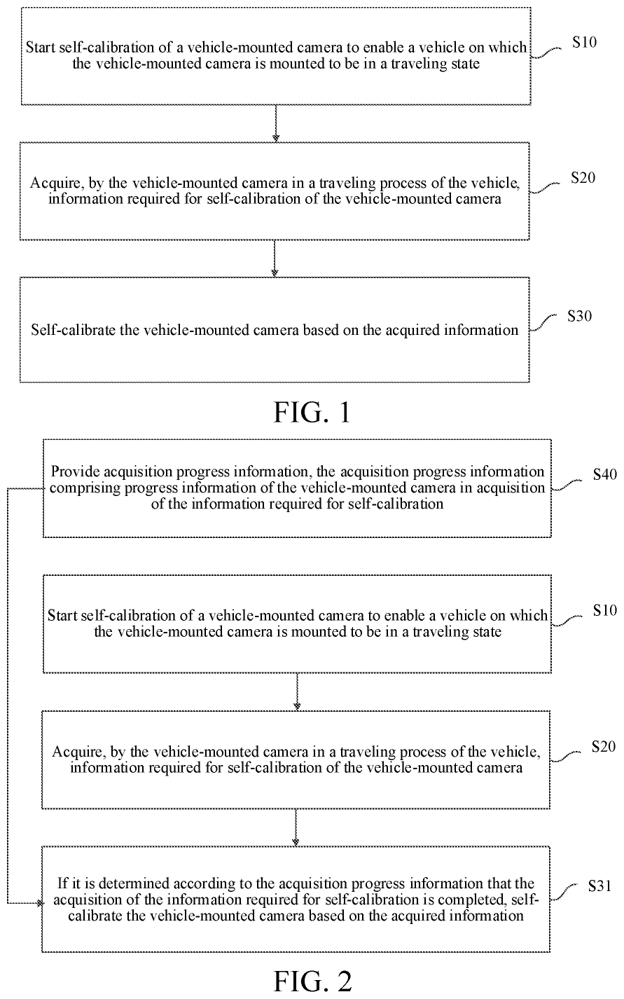

FIG. 1 is a flowchart illustrating a vehicle-mounted camera self-calibration method according to embodiments of the present disclosure. As shown in FIG. 1, the vehicle-mounted camera self-calibration method includes the following steps.

At step S10, self-calibration of a vehicle-mounted camera is started to enable a vehicle on which the vehicle-mounted camera is mounted to be in a traveling state.

The vehicle is a device having a traveling function, for example, in a possible implementation, the vehicle may include one or any combination of the following devices: a motor vehicle, a non-motor vehicle, a train, a toy car, or a robot.

The motor vehicle may be a vehicle, including a large automobile, a trolleybus, an electromobile, a motorcycle, a tractor, or the like, equipped with a power apparatus and is able to be driven to travel by the power apparatus. The non-motor vehicle may be a vehicle, including a bicycle, a tricycle, a scooter, an animal-drawn vehicles, or the like, required to be driven to travel by manpower or animal power. The toy car may be a toy, including a remote control toy car, an electric toy car, or the like, having the shape of a vehicle and being able to travel. The robot may include a humanoid traveling robot and a non-humanoid traveling robot. The non-humanoid traveling robot may include a floor mopping robot, a transfer robot, or the like.

The vehicle-mounted camera may be a camera configured on a vehicle by itself, or a peripheral camera on the vehicle. The vehicle-mounted camera may include various types of cameras, for example, may include a visible light camera, an infrared camera, a binocular camera, or the like. No limitation is made to the types of the vehicle-mounted camera in the present disclosure.

The self-calibration of the vehicle-mounted camera includes substantive work of self-calibration that could be completed by the vehicle-mounted camera per se. The self-calibration process of the vehicle-mounted camera does not require human intervention. For example, the vehicle-mounted camera may automatically perform calculation to obtain a calibration parameter according to a set self-calibration starting condition by using position information of a target object in an image captured by the vehicle-mounted camera during traveling of the vehicle and stored initial calibration information, and automatically completes calibration according to the calibration parameter. The entire calibration process eliminates the need to manually operate the vehicle-mounted camera, and does not require manual input of a calibration parameter, position information or the like.

The starting mode of the self-calibration of the vehicle-mounted camera may include a starting mode using manual input of an instruction, or an automatic starting mode based on a preset starting condition. The preset starting condition may include that the traveling condition of the vehicle satisfies the set traveling condition, or a photographing situation of the vehicle-mounted camera satisfies a set photographing condition. The starting condition may include a combination of a plurality of starting conditions, or the starting condition and the starting mode in the self-calibration process of the vehicle-mounted camera are determined according to needs. The implementation modes are flexible.

When the self-calibration of the vehicle-mounted camera is started, the vehicle on which the vehicle-mounted camera is mounted needs to be in the traveling state. Optionally, prompting information may be sent to enable the vehicle to enter the traveling state, and the user experience is improved. In the traveling process of the vehicle, the vehicle-mounted camera is in an on state, and performs photographing to obtain images. The vehicle-mounted camera may capture still images, or capture video streams.

A photographing mode of the vehicle-mounted camera and formats of captured images are determined according to needs, so that images satisfying the needs are obtained.

At step 20, by the vehicle-mounted camera in a traveling process of the vehicle, information required for self-calibration of the vehicle-mounted camera is acquired.

In one possible implementation, in the traveling process of the vehicle, information required for self-calibration of the vehicle-mounted camera is acquired according to images captured by the vehicle-mounted camera.

The information required for self-calibration of the vehicle-mounted camera may include images captured by the vehicle-mounted camera, or include processed images obtained by processing the images captured by the vehicle-mounted camera, or further include information of a target object detected in the images captured by the vehicle-mounted camera. The target object may include various types of objects such as a building, a vehicle, or a pedestrian.

In the traveling process of the vehicle, the information required for self-calibration of the vehicle-mounted camera is continuously acquired, or is acquired according to a set acquisition period. The implementation modes are flexible, and different application needs are satisfied.

At step S30, the vehicle-mounted camera is self-calibrated based on the acquired information.

In one possible implementation, if a mounting position or a photographing angle of view of the vehicle-mounted camera changes, re-calibration is required to be carried out on the vehicle-mounted camera, so that the images captured by the vehicle-mounted camera are used for performing accurate self-calibration of the vehicle-mounted camera. The self-calibration of the vehicle-mounted camera is performed based on the information acquired by the vehicle-mounted camera, and manual calibration by a user is not required.

The vehicle-mounted camera is self-calibrated by using the information acquired by the vehicle-mounted camera during traveling, in combination with the initial calibration information of the vehicle-mounted camera under a known condition.

In the present embodiment, when self-calibration of the vehicle-mounted camera is started, the vehicle-mounted camera may be self-calibrated according to information acquired by the vehicle-mounted camera in a traveling process of the vehicle. The self-calibration process of the vehicle-mounted camera is able to be conveniently completed in an actual application environment of vehicle-mounted cameras without affecting use of vehicles, calibration results are accurate, the calibration efficiency is high, and the embodiments have a wide application range.

In one possible implementation, starting self-calibration of a vehicle-mounted camera includes:

if it is detected that an angle of view or a focal length of the vehicle-mounted camera changes, starting the self-calibration of the vehicle-mounted camera.

In one possible implementation, the angle of view of the vehicle-mounted camera may include an included angle between the connecting lines from the center point of the lens to two ends of the diagonal line of an imaging plane. The focal length of the vehicle-mounted camera includes: a distance from the optical principle point back of the lens of the vehicle-mounted camera to the point of intersection. The angle of view of the vehicle-mounted camera is inversely proportional to the focal length of the vehicle-mounted camera. For the same imaging area, the shorter the focal length of the lens of the vehicle-mounted camera is, the greater the angle of view is.

Whether the angle of view or the focal length of the vehicle-mounted camera changes is detected by using the images captured by the vehicle-mounted camera, or by acquiring a vehicle-mounted camera parameter.

If the angle of view or the focal length of the vehicle-mounted camera changes, images captured by the vehicle-mounted camera regarding the same target object on the same position are different. Therefore, if the angle of view or the focal length of the vehicle-mounted camera changes, the self-calibration of the vehicle-mounted camera needs to be started, so that the self-calibrated vehicle-mounted camera is able to be used for acquiring accurate positioning information and the like.

In the present embodiment, if the angle of view or the focal length of the vehicle-mounted camera changes, the self-calibration of the vehicle-mounted camera is started. If the angle of view or the focal length of the vehicle-mounted camera changes, the vehicle-mounted camera is self-calibrated in time. The self-calibration of the vehicle-mounted camera does not affect normal traveling and normal use of vehicles. The vehicle-mounted camera may always maintain an accurate calibrated state.

In one possible implementation, starting self-calibration of a vehicle-mounted camera includes:

if it is detected that a mounting position and/or a photographing angle of the vehicle-mounted camera changes, starting the self-calibration of the vehicle-mounted camera.

In one possible implementation, the mounting position of the vehicle-mounted camera may include a mounting part of the vehicle-mounted camera on the vehicle. In the present embodiment, the vehicle-mounted camera is mounted at any part of the vehicle where the vehicle-mounted camera is able to photograph the road surface. The photographing angle of view of the vehicle-mounted camera may include an included angle between the lens plane of the vehicle-mounted camera and the horizon. The mounting position and the photographing angle of view of the vehicle-mounted camera are determined according to needs and an application environment.

If the mounting position and/or photographing angle of view of the vehicle-mounted camera changes, it can be considered that the application environments of the vehicle-mounted camera are different, and the vehicle-mounted camera are required to be self-calibrated again.

In the present embodiment, if the mounting position and/or the focal length of the vehicle-mounted camera changes, the self-calibration of the vehicle-mounted camera is started. If the mounting position or the photographing angle of view of the vehicle-mounted camera changes, the vehicle-mounted camera is self-calibrated in time. The self-calibration process of the vehicle-mounted camera does not affect the normal traveling and normal use of vehicles, and the vehicle-mounted camera may always maintain an accurate calibrated state.

In one possible implementation, starting self-calibration of a vehicle-mounted camera includes:

determining an accumulated mileage of the vehicle on which the vehicle-mounted camera is mounted; and

if the accumulated mileage is greater than a mileage threshold, starting the self-calibration of the vehicle-mounted camera.

In one possible implementation, if the accumulated mileage of the vehicle is greater than a mileage threshold, it can be considered that the application environment of the vehicle-mounted camera or the vehicle has greatly changed, and the vehicle-mounted camera is required to be self-calibrated.

The accumulated mileage of the vehicle is determined by reading the mileage of the vehicle. For example, if a change in the read mileage of the vehicle is greater than M kilometers, the self-calibration of the vehicle-mounted camera is started.

In the present embodiment, if the accumulated mileage of the vehicle is greater than a mileage threshold, the self-calibration of the vehicle-mounted camera is started. After the vehicle has been used for a certain period of time, vibration generated during the actual use process of the vehicle causes a change in the photographing angle of view or the mounting position of the vehicle-mounted camera, and therefore, if the accumulated mileage of the vehicle is greater than a mileage threshold, the vehicle-mounted camera is self-calibrated in time. The self-calibration process of the vehicle-mounted camera does not affect the normal traveling and normal use of vehicles, and the vehicle-mounted camera may always maintain an accurate calibrated state.

In one possible implementation, starting self-calibration of a vehicle-mounted camera includes:

starting the self-calibration of the vehicle-mounted camera according to a self-calibration start instruction.

In one possible implementation, in the present embodiment, when a self-calibration start instruction is received, the self-calibration of the vehicle-mounted camera is started. The received self-calibration start instruction may be a manually input self-calibration start instruction, or a self-calibration start instruction automatically sent by a preset execution program.

The self-calibration start instruction is received by providing an input mode for self-calibration start instructions. For example, a button for self-calibration start instructions may be provided, or a user may be guided to input a self-calibration start instruction by providing prompting information.

An automatic execution program is further provided so as to automatically send the self-calibration start instruction according to a preset execution period. For example, the self-calibration start instruction is sent every 20 days according to a set automatic execution program.

In the present embodiment, the self-calibration of the vehicle-mounted camera is started according to the self-calibration start instruction. The self-calibration of the vehicle-mounted camera is started in time according to use needs, and is also applicable to different application environments in time.

FIG. 2 is a flowchart illustrating a vehicle-mounted camera self-calibration method according to embodiments of the present disclosure. As shown in FIG. 2, the vehicle-mounted camera self-calibration method further includes the following steps.

At step S40, acquisition progress information is provided, the acquisition progress information including progress information of the vehicle-mounted camera in acquisition of the information required for self-calibration.

In one possible implementation, in order to make the self-calibration results more accurate, sufficient information is required to be acquired by the vehicle-mounted camera. The acquisition progress of the vehicle-mounted camera is prompted to the user of the vehicle by providing the acquisition progress information, so that the user experience is improved.

The acquisition progress information is provided by means of one or any combination of the following prompting information: voice prompting information, text prompting information, or image prompting information. The acquisition progress information may be provided actively, or be provided according to a prompting instruction.

For example, the acquisition progress information may be provided by displaying a progress bar on a central control screen of the vehicle, or by means of voice broadcasting “the current acquisition progress is: 20% acquired”.

No limitation is made to the form and providing modes of acquisition progress information in the present disclosure.

Step S30 includes:

at step 31, if it is determined according to the acquisition progress information that the acquisition of the information required for self-calibration is completed, the vehicle-mounted camera is self-calibrated based on the acquired information.

In one possible implementation, if the acquisition progress information prompts that the acquisition is not completed, the user of the vehicle needs to continue to maintain the traveling state to enable the vehicle-mounted camera to acquire sufficient information required for self-calibration. If the acquisition progress information prompts that the acquisition is completed, the vehicle-mounted camera is self-calibrated based on the acquired information.

In the present embodiment, by providing the acquisition progress information, the self-calibration process of the vehicle-mounted camera is clearer, and the user of the vehicle is able to master the progress of the self-calibration of the vehicle-mounted camera more conveniently. The success rate and the accuracy of the self-calibration of the vehicle-mounted camera are improved.

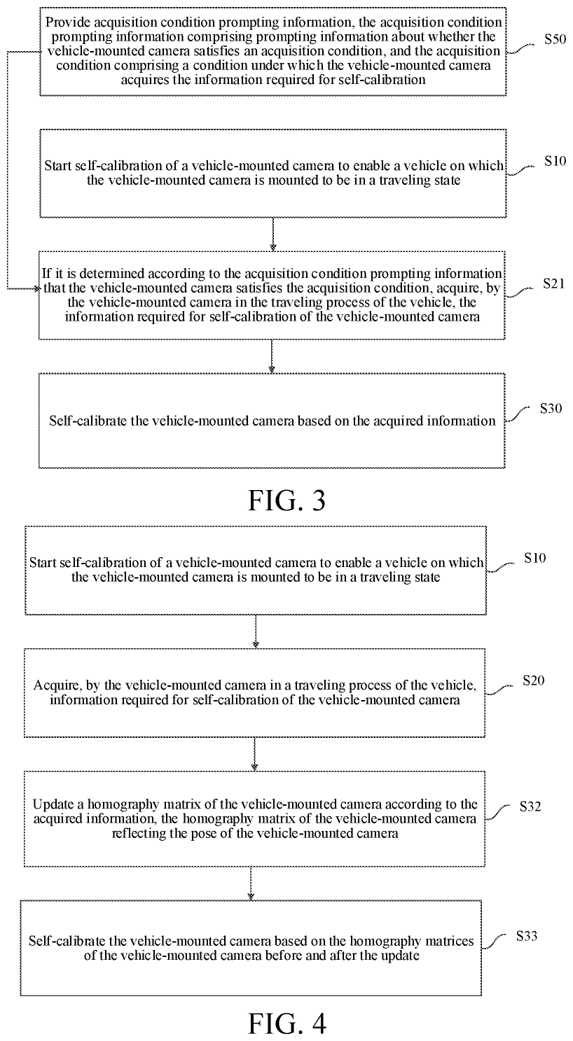

FIG. 3 is a flowchart illustrating a vehicle-mounted camera self-calibration method according to embodiments of the present disclosure. As shown in FIG. 3, the vehicle-mounted camera self-calibration method further includes the following steps.

At step 50, acquisition condition prompting information is provided, the acquisition condition prompting information including prompting information about whether the vehicle-mounted camera satisfies an acquisition condition, and the acquisition condition including a condition under which the vehicle-mounted camera acquires the information required for self-calibration.

In one possible implementation, in order to improve the success rate of the self-calibration of the vehicle-mounted camera, the vehicle-mounted camera is required to satisfy the acquisition condition for acquiring the information required for the self-calibration of the vehicle-mounted camera. The user of the vehicle is prompted, by providing the acquisition condition prompting information, to check whether the vehicle-mounted camera satisfies the acquisition condition.

The acquisition condition prompting information is provided by means of one or any combination of the following prompting information: voice prompting information, text prompting information, or image prompting information. The acquisition condition prompting information may be provided actively, or be provided according to a prompting instruction.

For example, the acquisition condition prompting information may be provided by displaying a relevant image or text on a central control screen of the vehicle, or by means of voice broadcasting “is there anything blocking the current photographing sight?”.

No limitation is made to the form and providing modes of acquisition condition prompting information in the present disclosure.

Step S20 includes:

at step S21, if it is determined according to the acquisition condition prompting information that the vehicle-mounted camera satisfies the acquisition condition, by the vehicle-mounted camera in the traveling process of the vehicle, the information required for self-calibration of the vehicle-mounted camera is acquired.

In one possible implementation, if it is determined that the vehicle-mounted camera does not satisfy the acquisition condition according to the acquisition condition prompting information, the user of the vehicle may perform the self-calibration of the vehicle-mounted camera after correspondingly adjusting the vehicle-mounted camera or changing the environment.

If it is determined according to the acquisition condition prompting information that the vehicle-mounted camera satisfies the acquisition condition, by the vehicle-mounted camera in the traveling process of the vehicle, the information required for self-calibration of the vehicle-mounted camera is acquired.

In the present embodiment, by means of the acquisition condition prompting information, the vehicle-mounted camera is able to acquire accurate information required for self-calibration, and the success rate and the accuracy of the self-calibration of the vehicle-mounted camera are improved.

In one possible implementation, step S20 includes:

if the lens pitch angle of the vehicle-mounted camera falls within a photographing pitch angle range, acquiring, by the vehicle-mounted camera in the traveling process of the vehicle, the information required for self-calibration of the vehicle-mounted camera.

In one possible implementation, the photographing pitch angle range may include a pitch angle set with the minimum pitch angle as the lower limit and the maximum pitch angle as the upper limit. A particular photographing pitch angle range is set according to different mounting positions, photographing angles of view and application environments of the vehicle-mounted camera.

If the photographing pitch angle of the vehicle-mounted camera falls beyond the photographing pitch angle range, the information required for self-calibration cannot be acquired from the image captured by the vehicle-mounted camera, or the acquired information is incomplete or inaccurate, and cannot be used for the self-calibration of the vehicle-mounted camera.

In the present embodiment, if the photographing pitch angle of the vehicle-mounted camera falls within the photographing pitch angle range, the vehicle-mounted camera is able to acquire the information required for self-calibration of the vehicle-mounted camera, and an accurate self-calibration result of the vehicle-mounted camera is obtained.

In one possible implementation, the information includes lane lines on the vehicle traveling road, and step S20 includes:

if the vehicle-mounted camera captures the lane lines on the vehicle traveling road, acquiring, by the vehicle-mounted camera in the traveling process of the vehicle, the information required for self-calibration of the vehicle-mounted camera.

In one possible implementation, there are lane lines on the vehicle traveling road in the traveling process of the vehicle. The lane lines may include white lane lines or yellow lane lines, or may include solid lines or dotted lines, or may include single lines or double lines. For example, the lane lines may be dotted white lines, solid white lines, solid yellow lines, dotted yellow lines, double dotted white lines, double solid yellow lines, or the like. The lane lines may also be shoulders of the road where a motor vehicle travels. In the image captured by the vehicle-mounted camera, the lane lines have characteristics such as a clear target and a uniform shape.

If the information required for self-calibration of the vehicle-mounted camera acquired by the vehicle-mounted camera is lane lines, the image captured by the vehicle-mounted camera is required to include the lane lines. If the vehicle-mounted camera captures the lane lines on the vehicle traveling road, by the vehicle-mounted camera in the traveling process of the vehicle, the information required for self-calibration of the vehicle-mounted camera is acquired. The vehicle-mounted camera is able to be self-calibrated based on the acquired information.

In the present embodiment, if the vehicle-mounted camera captures the lane lines on the vehicle traveling road, by the vehicle-mounted camera in the traveling process of the vehicle, the information required for self-calibration of the vehicle-mounted camera is acquired. It is ensured that the vehicle-mounted camera captures the lane lines on the vehicle traveling road, and the vehicle-mounted camera is able to be self-calibrated based on the acquired information. The self-calibration of the vehicle-mounted camera has a wide application range, and a simple and reliable calibration process.

In one possible implementation, acquiring, by the vehicle-mounted camera in a traveling process of the vehicle, information required for self-calibration of the vehicle-mounted camera includes:

if the vehicle-mounted camera captures a horizon line on the vehicle traveling road or a vanishing point of the lane lines, acquiring, by the vehicle-mounted camera in the traveling process of the vehicle, the information required for self-calibration of the vehicle-mounted camera.

In one possible implementation, if the vehicle-mounted camera captures a horizon line on the vehicle traveling road or a vanishing point of the lane lines, it can be determined that the vehicle-mounted camera is not blocked at the front. The lane lines captured by the vehicle-mounted camera are complete and clear. The vehicle-mounted camera is accurately self-calibrated according to the complete and clear lane lines.

In the present embodiment, if the vehicle-mounted camera captures a horizon line on the vehicle traveling road or a vanishing point of the lane lines, the vehicle-mounted camera is able to obtain a more accurate self-calibration result of the vehicle-mounted camera according to the complete and clear lane lines photographed.

In one possible implementation, step S20 includes:

acquiring, by the vehicle-mounted camera in the traveling process of the vehicle, the information required for self-calibration of the vehicle-mounted camera within an acquisition duration range.

In one possible implementation, the acquisition duration range may include a duration range with the minimum acquisition duration as the lower limit and the maximum acquisition duration as the upper limit. If the acquisition duration in which the vehicle-mounted camera acquires the information required for self-calibration does not reach the minimum acquisition duration, the acquired information is insufficient to support calculation on self-calibration of the vehicle-mounted camera. If the acquisition duration in which the vehicle-mounted camera acquires the information required for self-calibration exceeds the maximum acquisition duration, the information acquired by the vehicle-mounted camera after the maximum acquisition duration is exceeded may not participate in the calculation on self-calibration. A preset acquisition duration range is set according to needs, for example, the acquisition duration range may be 10 to 25 minutes.

If the acquisition duration of the vehicle-mounted camera exceeds the maximum acquisition duration determined by the acquisition duration range, acquisition of the information required for self-calibration by the vehicle-mounted camera is ended, and unnecessary waste of system resources is prevented.

In the present embodiment, according to the acquisition duration range, the information acquired by the vehicle-mounted camera is sufficient to support the calculation on self-calibration, and no waste of system resources is caused.

In one possible implementation, acquiring, by the vehicle-mounted camera in a traveling process of the vehicle, information required for self-calibration of the vehicle-mounted camera includes:

acquiring, by the vehicle-mounted camera in the traveling process of the vehicle, the information required for self-calibration of the vehicle-mounted camera if a traveling distance of the vehicle falls within a traveling distance range.

In one possible implementation, the traveling distance range may include a distance range with the minimum traveling distance as the lower limit and the maximum traveling distance as the upper limit. In the traveling process of the vehicle, the longer the traveling distance of the vehicle is, the more information the vehicle-mounted camera acquires. If the traveling distance of the vehicle is less than the minimum traveling distance, the information acquired by the vehicle-mounted camera is insufficient to support the calculation on self-calibration. If the traveling distance of the vehicle is greater than the maximum traveling distance, the information acquired by the vehicle-mounted camera after the maximum traveling distance is exceeded may not participate in the calculation on self-calibration. The traveling distance range is determined according to needs, configuration of the vehicle-mounted camera, and the actual application environment of the vehicle-mounted camera, for example, the traveling distance range may be 5 to 8 kilometers.

If the traveling distance of the vehicle-mounted camera exceeds the maximum traveling distance determined by the traveling distance range, acquisition of the information required for self-calibration by the vehicle-mounted camera is ended, and unnecessary waste of system resources is prevented.

In the present embodiment, according to the traveling distance range, the information acquired by the vehicle-mounted camera is sufficient to support the calculation on self-calibration, and no waste of system resources is caused.

FIG. 4 is a flowchart illustrating a vehicle-mounted camera self-calibration method according to embodiments of the present disclosure. As shown in FIG. 4, step S30 in the vehicle-mounted camera self-calibration method includes:

at step S32, a homography matrix of the vehicle-mounted camera is updated according to the acquired information, the homography matrix of the vehicle-mounted camera reflecting the pose of the vehicle-mounted camera.

In one possible implementation, the pose of the vehicle-mounted camera may include a rotation parameter and a translation parameter of the vehicle-mounted camera. The homography matrix of the vehicle-mounted camera is established according to the pose of the vehicle-mounted camera. The homography matrix of the vehicle-mounted camera may include a conversion parameter, a conversion matrix, or the like of the vehicle-mounted camera. By using the homography matrix of the vehicle-mounted camera, points in the image captured by the vehicle-mounted camera and coordinates in an image coordinate system and a world coordinate system are able to be converted mutually.

The process for establishing the homography matrix of the vehicle-mounted camera includes: using the camera provided on the vehicle to capture a real road image, and constructing the homography matrix by using a set of points on the road image and a corresponding set of points on the real road. A specific method may include: 1. coordinate system establishment: establishing a vehicle body coordinate system by taking the left front wheel of the vehicle as an origin, a rightward direction of the angle of view of a driver as a positive direction of X axis, and a frontward direction as a positive direction of Y axis; 2. point selection: selecting points in the vehicle body coordinate system of the vehicle to obtain a set of selected points, such as (0, 5), (0, 10), (0, 15), (1.85, 5), (1.85, 10), and (1.85, 15), the unit of each point being meter, where farther points may also be selected as needed; 3. marking: marking the selected point on the real road to obtain a set of real points; 4. calibration: obtaining a corresponding pixel position of the set of real points in the photographed image by using the calibration plate and a calibration program; and 5. generating the homography matrix according to the corresponding pixel position.

The homography matrix is constructed for the vehicle-mounted camera under a known angle of view when the vehicle-mounted camera is first used, or first mounted, or shipped.

According to the constructed homography matrix of the vehicle-mounted camera, coordinates of the target object in the image captured by the vehicle-mounted camera under the known angle of view are mutually converted between the image coordinate system of the image captured under the known angle of view and the world coordinate system.

In the traveling process of the vehicle, after the vehicle-mounted camera acquires the information required for self-calibration of the vehicle-mounted camera, the homography matrix of the vehicle-mounted camera is updated. For example, the homography matrix of the vehicle-mounted camera is updated according to the lane lines captured by the vehicle-mounted camera during traveling.

According to the updated homography matrix of the vehicle-mounted camera, the coordinates of the target object in the image captured by the vehicle-mounted camera under a driving photographing angle of view are mutually converted between the image coordinate system of the image captured under the driving photographing angle of view and the world coordinate system.

At step S33, the vehicle-mounted camera is self-calibrated based on the homography matrices of the vehicle-mounted camera before and after the update.

In one possible implementation, the homography matrix of the vehicle-mounted camera before the update may include a conversion relation between the image coordinate system of the image captured by the vehicle-mounted camera under the known angle of view and the world coordinate system. The homography matrix of the vehicle-mounted camera before the update may include a known parameter or a known matrix of the vehicle-mounted camera.

The homography matrix of the vehicle-mounted camera after the update may include a conversion relation between the image coordinate system of the image captured by the vehicle-mounted camera under the driving photographing angle of view and the world coordinate system. The homography matrix of the vehicle-mounted camera after the update may include a conversion parameter or a conversion matrix of the vehicle-mounted camera.

According to the homography matrices of the vehicle-mounted camera before and after the update, first image coordinates of the target object in a first image captured by the vehicle-mounted camera under the known angle of view and second image coordinates of the target object in a second image captured by the vehicle-mounted camera under the driving photographing angle of view are able to be converted mutually. The vehicle-mounted camera is self-calibrated according to the conversion relation between the first image coordinates and the second image coordinates.

In the present embodiment, the vehicle-mounted camera is self-calibrated by updating the homography matrix of the vehicle-mounted camera, and according to the homography matrices of the vehicle-mounted camera before and after the update. By using the homography matrix of the vehicle-mounted camera, the vehicle-mounted camera is self-calibrated accurately and quickly.

In one possible implementation, step S32 includes:

detecting the lane lines in an image captured by the vehicle-mounted camera to obtain detected position information of the lane lines; and

updating the homography matrix of the vehicle-mounted camera according to the detected position information of the lane lines.

In one possible implementation, the lane lines are detected in the image captured by the vehicle-mounted camera by using an image recognition technology, or according to output of a neural network after the image captured by the vehicle-mounted camera is input into the neural network.

The image captured by the vehicle-mounted camera includes an image captured by the vehicle-mounted camera under the driving photographing angle of view when the vehicle travels. The detected position information of the lane lines includes position information of the lane lines in the image coordinate system of the image captured by the vehicle-mounted camera under the driving photographing angle of view.

The homography matrix of the vehicle-mounted camera is updated according to the position information of the lane lines in the image captured under the driving photographing angle of view. According to the updated homography matrix, the position information of the lane lines in the image captured under the driving photographing angle of view and position information of the lane lines in the image captured under the known angle of view are able to be converted mutually.

In the present embodiment, after the lane lines are detected in the image captured by the vehicle-mounted camera, the homography matrix of the vehicle-mounted camera is updated based on the detected position of the lane lines. Accurate lane lines are detected in the image and accurate detected position information of the lane lines is obtained. An accurate homography matrix after the updated is obtained according to the accurate detected position information of the lane lines, the homography matrix after the update is used for self-calibration of the vehicle-mounted camera, and an accurate self-calibration result is obtained.

In one possible implementation, step S33 includes:

at step S331, known position information of the lane lines is obtained according to the homography matrix of the vehicle-mounted camera before the update.

In one possible implementation, the homography matrix of the vehicle-mounted camera before the update may include the constructed homography matrix of the vehicle-mounted camera under the known angle of view when the vehicle-mounted camera is first used, or first mounted, or shipped. According to the constructed homography matrix of the vehicle-mounted camera, coordinates of the target object in the image captured by the vehicle-mounted camera under the known angle of view are mutually converted between the image coordinate system of the image captured under the known angle of view and the world coordinate system.

According to the homography matrix before the update, the known position information of the lane lines is obtained, including the position information of the lane lines in the image coordinate system of the image captured under the known angle of view and the position information of the lane lines in the world coordinate system.

At step S332, a calibration parameter of the vehicle-mounted camera is determined according to the detected position information of the lane lines and the known position information of the lane lines.

In one possible implementation, parameters of the vehicle-mounted camera may include an intrinsic parameter and an extrinsic parameter. The intrinsic parameters may include parameters such as the focal length of the vehicle-mounted camera, the size of pixels, and the like, which are related with the characteristics of the vehicle-mounted camera, and the intrinsic parameter of each vehicle-mounted camera is unique. The extrinsic parameters include a position parameter and a rotation direction parameter of the vehicle-mounted camera in the world coordinate system. The calibration parameter of the vehicle-mounted camera may include the rotation direction parameter of the vehicle-mounted camera. By using the calibration parameter, a mapping relation between the world coordinate system and the image coordinate system of the image captured by the vehicle-mounted camera is constructed, and by using the mapping relation constructed using the calibration parameter, the position information of the target object in the image coordinate system and the position information in the world coordinate system are able to be converted mutually.

A known parameter of the vehicle-mounted camera is obtained according to the known position information of the lane lines in the world coordinate system, and the known position information of the lane lines in the image coordinate system of the image captured by the vehicle-mounted camera under the known angle of view. Then the calibration parameter of the vehicle-mounted camera under the driving photographing angle of view is obtained according to the known parameter of the vehicle-mounted camera and the conversion parameter between the driving photographing angle of view of the vehicle-mounted camera and the known angle of view.

At step S333, the vehicle-mounted camera is self-calibrated based on the calibration parameter.

In one possible implementation, after the vehicle-mounted camera is self-calibrated according to the calibration parameter, coordinate information of the object in the image captured by the vehicle-mounted camera under the driving photographing angle of view is mutually converted between the image coordinate system of the image captured under the driving photographing angle of view and the world coordinate system.

In the present embodiment, the calibration parameter of the vehicle-mounted camera is obtained according to the detected position information and the known position information of the lane lines, and the vehicle-mounted camera is self-calibrated according to the calibration parameter. The vehicle-mounted camera is self-calibrated according to the calibration parameter, so that the vehicle-mounted camera is able to conveniently complete self-calibration, the calibration efficiency is high, and the embodiments have a wide application range.

In one possible implementation, detecting the lane lines in an image captured by the vehicle-mounted camera to obtain detected position information of the lane lines includes:

detecting the lane lines in the image captured by the vehicle-mounted camera; and

determining key points on the detected lane lines to obtain detected coordinates of the key points.

Determining a calibration parameter of the vehicle-mounted camera according to the detected position information of the lane lines and the known position information of the lane lines includes: determining the calibration parameter of the vehicle-mounted camera according to the detected coordinates of the key points and known coordinates of the key points.

In one possible implementation mode, the key points may include points at specified positions on the lane lines, or may include points having set characteristics on the lane lines. The key points on the lane lines are determined according to needs. There may be one or more key points on the lane lines, and the quantity of the key points is determined according to needs.

The detected coordinates of the key points may include position information of the key points in the image coordinate system of the image captured by the vehicle-mounted camera under the driving photographing angle of view. For example, the detected coordinates of a key point 1 on the lane lines are (X₁, Y₁), and detected coordinates of a key point 2 on the lane lines are (X₂, Y₂).

The known coordinates of the key points may include known coordinates of the key points in the world coordinate systems, and known coordinates in the image coordinate system of the image captured by the vehicle-mounted camera under the known angle of view.

The conversion parameter of the vehicle-mounted camera is obtained using the known coordinates and the detected coordinates of the key points, the known parameter of the vehicle-mounted camera is obtained using the known coordinates of the key points, and the calibration parameter of the vehicle-mounted camera is obtained finally using the known parameter and the conversion parameter of the vehicle-mounted camera.

In the present embodiment, the calibration parameter of the vehicle-mounted camera is obtained using the detected coordinates and the known coordinates of the key points. Regarding the calibration parameter obtained according to the detected coordinates and the known coordinates of the key points, the calculation amount is small. The vehicle-mounted camera is able to quickly and accurately complete self-calibration, the calibration efficiency is high, and the embodiments have a wide application range.

In one possible implementation, detecting the lane lines in an image captured by the vehicle-mounted camera to obtain detected position information of the lane lines includes:

performing lane line detection in images captured by the vehicle-mounted camera to obtain lane lines to be fitted in the images; and

fitting the lane lines to be fitted in the images to obtain the lane lines and the detected position information of the lane lines.

In one possible implementation, the lane line detection is performed on a plurality of images captured by the vehicle-mounted camera. The quantity and positions of the detected lane lines are determined according to needs. For example, the lane line on the left side of the vehicle may be detected, or the lane line on the right side of the vehicle may be detected. When there are multiple lanes on the road surface, the closest two lane lines on the left and right sides of the vehicle are detected, or merely two lane lines on the right side of the vehicle are detected.

When the vehicle travels on the road surface, in the plurality of images captured by the vehicle-mounted camera, the positions of the lane lines in the images are relatively fixed. The lane lines to be fitted are detected in the images, the lane lines to be fitted in the plurality of images are fitted to obtain the lane lines, and the detected position information of the lane lines is obtained.

If it is determined that the lane lines to be detected are lane lines of the lane where the vehicle travels, the lane lines to be detected are the closest two lane lines on the left and right sides of the vehicle. According to the lane lines to be fitted detected in the plurality of images captured by the vehicle-mounted camera, the two lane lines on the left and right sides of the lane where the vehicle travels are obtained by means of fitting, and the detected position information of the two lane lines on the left and right sides is obtained.

For example, the lane lines to be fitted are detected in 100 images captured by the vehicle-mounted camera, and are lane lines within 5 meters ahead the front end of the vehicle in the images. The lane lines to be fitted detected in the 100 images are fitted to obtain the lane lines of the vehicle traveling road, and obtain the detected position information of the lane lines.

The calibration parameter of the vehicle-mounted camera is obtained according to the known position information and the detected position information of the lane lines.

In the present embodiment, based on detected position information of the lane lines obtained using the lane lines to be fitted detected in the multiple images, possible positional deviations of the lane lines to be fitted in the images are eliminated, so that the self-calibration result of the vehicle-mounted camera is more accurate.

In one possible implementation, the lane lines include a first lane line and a second lane line, and determining key points on the detected lane lines to obtain detected coordinates of the key points includes:

determining points of intersection between the first lane lines and the second lane lines in the images according to the detected first lane lines and the detected second lane lines in the images;

determining horizon lines according to the points of intersection in the images; and

determining key points according to the horizon lines, the first lane lines, and the second lane lines to obtain detected coordinates of the key points.

In one possible implementation, the first lane line and the second lane line may separately be a lane line on the left or right side of the vehicle. For example, the first lane line may be the closest lane line on the left side of the vehicle, and the second lane line may be the closest lane line on the right side of the vehicle. The first lane line and the second lane line may be two parallel lines on the real road. In the images captured by the vehicle-mounted camera, the first lane line and the second lane line may have a point of intersection in the front, or the extending line of the first lane line and the extending line of the second lane line may have a point of intersection in the front.

The first lane line and the second lane line are separately detected in the images captured by the vehicle-mounted camera, and the point of intersection between the first lane line and the second lane line are determined in the images.

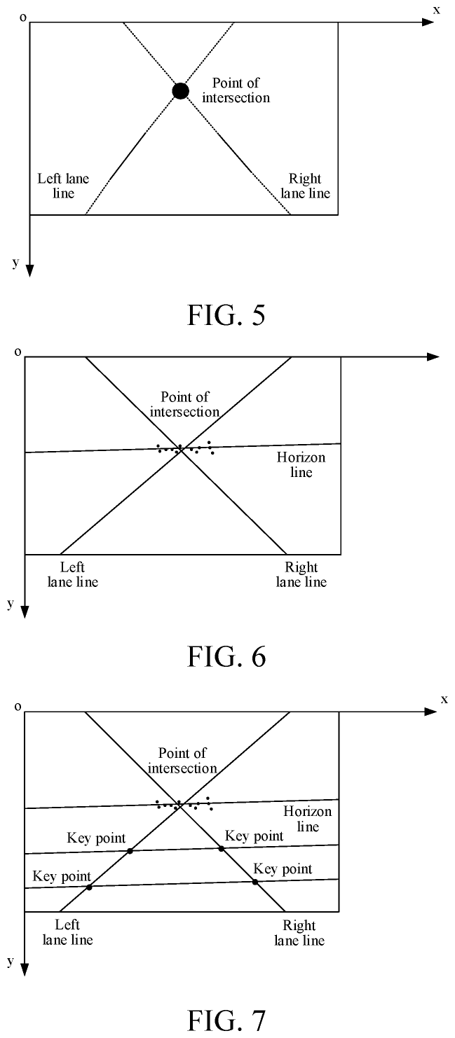

FIG. 5 is a schematic diagram illustrating points of intersection in a vehicle-mounted camera self-calibration method according to embodiments of the present disclosure. As shown in FIG. 5, the coordinate system in FIG. 5 is the image coordinate system, the first lane line is a left lane line, the second lane line is a right lane line, and the extending line of the left lane line and the extending line of the right lane line have a point of intersection in front of the motor vehicle.

In one possible implementation, on the real road where the vehicle travels, the first lane line and the second lane line may intersect each other on the horizon line, and therefore, the positions of the horizon lines in front of the vehicles are obtained by means of fitting according to the points of intersection in the images, and the sum of the distances from the points of intersection to the horizon lines obtained by means of fitting in the images is minimal.

FIG. 6 is a schematic diagram illustrating a horizon line in a vehicle-mounted camera self-calibration method according to embodiments of the present disclosure. As shown in FIG. 6, the coordinate system in FIG. 6 is the image coordinate system, there are 12 points of intersections determined according to the image, and the horizon line is determined according to the 12 points of intersections. The sum of the distance from the points of intersections to the determined horizon line is minimal.

In one possible implementation, the determined positions of the horizon lines in the images are relatively fixed. If the lane lines include a first lane line and a second lane line, in order to make the error between the detected positions of the key points in the images minimal and make the detected position information and the known position information of the key points more accurate, with reference to the determined horizon line, the key points are determined on the first lane line and the second lane line.

For example, in the images, by taking the length from the horizon line as M, a key point 1 and a key point 2 are respectively determined on the first lane line and the second lane line, and by taking the length from the horizon line as N, a key point 3 and a key point 4 are respectively determined on the first lane line and the second lane line, wherein M and N have the same unit and are different in value.

In the images, the detected coordinates of the key points are obtained according to the determined key points. The detected coordinates of the key points may include the coordinates of the key points in the image coordinate system of the image captured under the driving photographing angle of view.

In the present embodiment, after two lane lines are detected in the image, the horizon line obtained according to the two lane lines, and after the positions of the key points are determined according to the position of the horizon line, the detected coordinates of the key points are obtained. The accurate positions of the key points in the image are obtained according to the horizon lines, and therefore, a more accurate correction parameter is obtained.

In one possible implementation, determining key points according to the horizon lines, the first lane lines, and the second lane lines to obtain detected coordinates of the key points includes:

determining detection lines parallel with the horizon lines and separately intersecting the first lane lines and the second lane lines; and

determining cross points between the detection lines and the first lane lines, and cross points between the detection lines and the second lane lines as the key points to obtain the detected coordinates of the key points.

FIG. 7 is a schematic diagram illustrating key points in a vehicle-mounted camera self-calibration method according to embodiments of the present disclosure. As shown in FIG. 7, the coordinate system in the drawing is the image coordinate system, there are two detection lines under the horizon line and parallel with the horizon line, and four cross points of the detection lines with the left lane line and the right lane line are determined as the key points.

In one possible implementation, determining the calibration parameter of the vehicle-mounted camera according to the detected coordinates of the key points and known coordinates of the key points includes:

determining a conversion parameter of the camera according to the detected coordinates of the key points and the known coordinates of the key points, the detected coordinates of the key points including coordinates of the key points in a driving photographing angle of view, and the known coordinates of the key points including coordinates of the key points in a known angle of view; and

determining the calibration parameter of the camera according to the conversion parameter and a known parameter.

In one possible implementation, the known coordinates of the key points include the known coordinates of the key points in the image coordinate system of the image captured by the vehicle-mounted camera under the known angle of view. For example, the known coordinates of the key point in the image are (X_{A}, Y_{A}) when the vehicle-mounted camera is under the known angle A of view. According to the known angle A of view and the known coordinates (X_{A}, Y_{A}), a known parameter HA of the vehicle-mounted camera when the vehicle-mounted camera is under the known angle A of view is obtained, and the known parameter HA may include a parameter in the form of a matrix, or may include a rotation direction parameter of the vehicle-mounted camera. The coordinates of the key point in the image coordinate system of the image captured under the known angle A of view is able to be converted to the world coordinate system according to the known parameter H_{A}.

The detected coordinates of the key point may include the detected coordinates of the key point in the image coordinate system of the image captured by the vehicle-mounted camera under the driving photographing angle of view. For example, the detected coordinates of the key point in the image are (X_{B}, Y_{B}) when the vehicle-mounted camera is under the driving photographing angle B of view.

A conversion parameter H_{AB} of the vehicle-mounted camera from the known angle A of view to the driving photographing angle B of view according to the known coordinates (X_{A}, Y_{A}) and the detected coordinates (X_{B}, Y_{B}).The conversion parameter H_{AB} may include a parameter in the form of a matrix, or may include a rotation direction parameter of the vehicle-mounted camera. According to the conversion parameter H_{AB}, the coordinates of the key points are mutually converted between the image coordinate system of the image captured under the known angle A of view and the image coordinate system of the image captured under the driving photographing angle B of view.

In one possible implementation, a detection parameter H_{B} of the vehicle-mounted camera under the driving photographing angle B of view is obtained according to the conversion parameter H_{AB} and the known parameter H_{A}. The detection parameter H_{B} may include a parameter in the form of a matrix, or may include a rotation direction parameter of the vehicle-mounted camera. The coordinates of the key points in the image coordinate system of the image captured under the driving photographing angle B of view is able to be converted to the world coordinate system according to the detection parameter H_{B}. The detection parameter H_{B} is the calibration parameter of the vehicle-mounted camera under the driving photographing angle B of view.

In one possible implementation, the known coordinates of the key points include: first known coordinates of the key points in an image coordinate system in the known angle of view, and second known coordinates of the key points in a world coordinate system in the known angle of view.

Determining the calibration parameter of the camera according to the conversion parameter and a known parameter includes:

determining the known parameter according to the first known coordinates and the second known coordinates; and determining the calibration parameter of the camera according to the conversion parameter and the known parameter.

In one possible implementation, the known coordinates of the key point include the known coordinates (X_{A}, Y_{A}) of the key point in the image captured by the vehicle-mounted camera under the known angle A of view and known world coordinates (X, Y, 1) of the key point in the world coordinate system. According to the known coordinates (XA, YA) and the known world coordinates (X, Y, 1), the known parameter HA of the vehicle-mounted camera under the known angle A of view is obtained, and the detection parameter H_{B} under the driving photographing angle B of view is obtained according to the known parameter H_{A} and the conversion parameter H_{AB}.

In the present embodiment, the calibration parameter of the vehicle-mounted camera is determined according to the known coordinates of the vehicle-mounted camera under the known angle of view and the detected coordinates of the vehicle-mounted camera under the driving photographing angle of view. According to the known coordinates and the detected coordinates of the key point, the calibration of the vehicle-mounted camera is facilitated, the calculation process is simple, and the calculation result is accurate.

In one possible implementation, the method further includes:

correcting the calibration parameter using a perspective principle or a triangle principle according to a correction parameter of the vehicle-mounted camera.

In one possible implementation, the correction parameter of the vehicle-mounted camera may include a correction parameter calculated according to the focal length and the unit pixel of the vehicle-mounted camera. The focal length and the unit pixel of each vehicle-mounted camera are different, and the correction parameter is calculated according to parameters of the vehicle-mounted camera itself. The conversion parameter of the vehicle-mounted camera is more precisely corrected using a perspective principle or a triangle principle.

For example, f represents the focal length (millimeter) of the vehicle-mounted camera, and pm represents pixels of the vehicle-mounted camera/millimeter. The corrected H′_{BA} is:

$${H}_{B A}^{′} = [ \begin{matrix}{k}^{′} {h}_{11} & {k}^{′} {h}_{12} & {k}^{′} {h}_{13} \\ k {h}_{21} + {b}_{1} & k {h}_{22} + {b}_{2} & k {h}_{23} + {b}_{3} \\ {h}_{31} & {h}_{32} & {h}_{33}\end{matrix} ] \qquad Formula ( 1 )$$

where k′ represents a first correction coefficient, k represents a second correction coefficient, and b represents a third correction coefficient.

In the present embodiment, the correction parameter of the vehicle-mounted camera itself is substituted into the calculation process for the conversion parameter, so that the conversion parameter is more accurate and more adapts to individual characteristics of the vehicle-mounted camera.

The embodiments of the present disclosure further provide a vehicle driving method, including:

performing vehicle driving using the self-calibrated vehicle-mounted camera.

In one possible implementation mode, the vehicle driving may include active vehicle driving and assisted vehicle driving. Accurate positioning information is provided for the vehicle by using the self-calibrated vehicle-mounted camera, making the active driving and the assisted driving of the vehicle more safe and reliable.

The calibration parameter is stored in a driver assistant system which uses the vehicle-mounted camera as a sensor, so as to provide effective calibration parameter for subsequent image processing in the assisted driving. The driver assistant system may include a system implementing assisted driving according to position information of a specific target object.

For example, the driver assistant system may include: a lane-keeping assistant system, a brake assistant system, an automatic parking assistant system, and a backing assistant system. The lane-keeping assistant system performs assisted driving according to the lane lines where the vehicle travels to keep the vehicle traveling on the lane. The brake assistant system sends a brake instruction to the vehicle according to a distance from a set target object to enable the vehicle to keep a safe distance from the target object. The automatic parking assistant system backs the vehicle into a garage according to a detected parking line. The backing assistant system sends a backing instruction to the vehicle according to the distance between the motor vehicle and an obstacle behind, to keep the vehicle away from the obstacle.

The vehicle obtains the accurate position information of the target object in the image captured by the vehicle-mounted camera according to the accurate calibration parameter of the vehicle-mounted camera, and the driver assistant system obtains an assisted driving instruction according to the position information of the target object.

In the present embodiment, by using the self-calibrated vehicle-mounted camera, driving of vehicles becomes more safe and reliable, without affecting the actual application of the vehicles.

It can be understood that the foregoing various method embodiments mentioned in the present disclosure may be combined with each other to form a combined embodiment without departing from the principle logic. Details are not described in the present disclosure again due to space limitation.

In addition, the present disclosure further provides an image processing apparatus, an electronic device, a computer readable storage medium, and a program, which can all be configured to implement any one of the image processing methods provided in the present disclosure. For the corresponding technical solutions and descriptions, please refer to the corresponding contents in the method parts. Details are not described herein again.

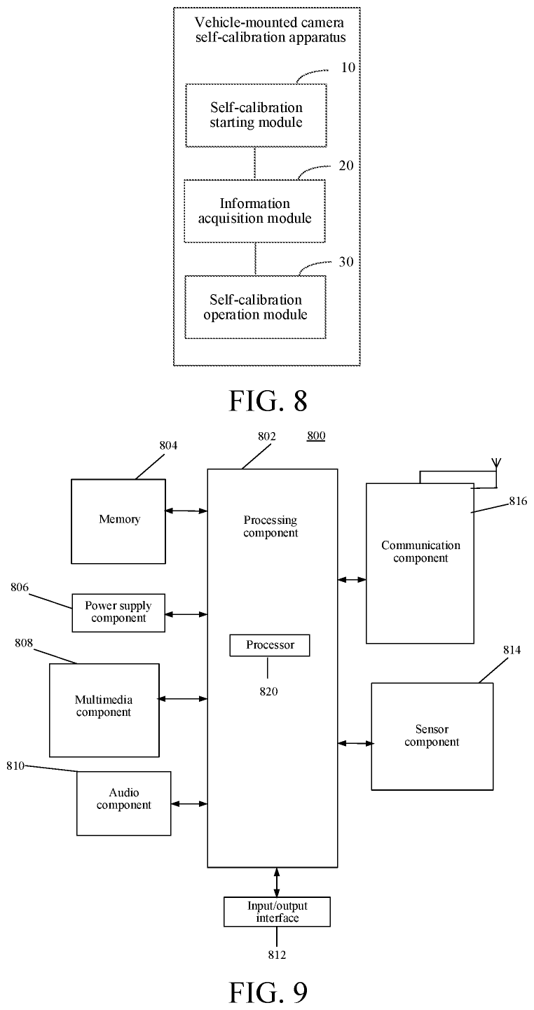

FIG. 8 is a block diagram illustrating a vehicle-mounted camera self-calibration apparatus according to embodiments of the present disclosure. As shown in FIG. 8, the vehicle-mounted camera self-calibration apparatus includes: a self-calibration starting module 10, configured to start self-calibration of a vehicle-mounted camera to enable a vehicle on which the vehicle-mounted camera is mounted to be in a traveling state; an information acquisition module 20, configured to acquire, by the vehicle-mounted camera in a traveling process of the vehicle, information required for self-calibration of the vehicle-mounted camera; and a self-calibration operation module 30, configured to self-calibrate the vehicle-mounted camera based on the acquired information. In the present embodiment, when self-calibration of the vehicle-mounted camera is started, the vehicle-mounted camera may be self-calibrated according to information acquired by the vehicle-mounted camera in a traveling process of the vehicle. The self-calibration process of the vehicle-mounted camera is able to be conveniently completed in an actual application environment of vehicle-mounted cameras without affecting use of vehicles, calibration results are accurate, the calibration efficiency is high, and the embodiments have a wide application range.

In one possible implementation, the self-calibration starting module 10 includes: a first self-calibration starting sub-module, configured to, if it is detected that an angle of view or a focal length of the vehicle-mounted camera changes, start the self-calibration of the vehicle-mounted camera, making the vehicle-mounted camera always maintain an accurate calibrated state.

In one possible implementation, the self-calibration starting module 10 includes: a second self-calibration starting sub-module, configured to, if it is detected that a mounting position and/or a photographing angle of the vehicle-mounted camera changes, start the self-calibration of the vehicle-mounted camera, making the vehicle-mounted camera always maintain an accurate calibrated state.

In one possible implementation, the self-calibration starting module 10 includes: a third self-calibration starting sub-module, configured to determine an accumulated mileage of the vehicle on which the vehicle-mounted camera is mounted; and if the accumulated mileage is greater than a mileage threshold, start the self-calibration of the vehicle-mounted camera, making the vehicle-mounted camera always maintain an accurate calibrated state.

In one possible implementation, the self-calibration starting module 10 includes: a fourth self-calibration starting sub-module, configured to start the self-calibration of the vehicle-mounted camera according to a self-calibration start instruction. The self-calibration of the vehicle-mounted camera is started in time according to use needs, and is also applicable to different application environments in time.

In one possible implementation, the apparatus further includes: a progress information providing module, configured to provide acquisition progress information, the acquisition progress information including progress information of the vehicle-mounted camera in acquisition of the information required for self-calibration; and the self-calibration operation module 30 includes: a first self-calibration operation sub-module, configured to, if it is determined according to the acquisition progress information that the acquisition of the information required for self-calibration is completed, self-calibrate the vehicle-mounted camera based on the acquired information. The acquisition progress of the vehicle-mounted camera is prompted to the user of the vehicle by providing the acquisition progress information, so that the user experience is improved.

In one possible implementation, the apparatus further includes: an acquisition condition prompting information, configured to provide acquisition condition prompting information, the acquisition condition prompting information including prompting information about whether the vehicle-mounted camera satisfies an acquisition condition, and the acquisition condition including a condition under which the vehicle-mounted camera acquires the information required for self-calibration; and the information acquisition module 20 includes: a first information acquisition sub-module, configured to, if it is determined according to the acquisition condition prompting information that the vehicle-mounted camera satisfies the acquisition condition, acquire, by the vehicle-mounted camera in the traveling process of the vehicle, the information required for self-calibration of the vehicle-mounted camera. In the present embodiment, if the vehicle-mounted camera captures the lane lines on the vehicle traveling road, by the vehicle-mounted camera in the traveling process of the vehicle, the information required for self-calibration of the vehicle-mounted camera is acquired. It is ensured that the vehicle-mounted camera captures the lane lines on the vehicle traveling road, and the vehicle-mounted camera is able to be self-calibrated based on the acquired information. The self-calibration of the vehicle-mounted camera has a wide application range, and a simple and reliable calibration process.

In one possible implementation, the information acquisition module 20 includes: a second information acquisition sub-module, configured to, if the lens pitch angle of the vehicle-mounted camera falls within a photographing pitch angle range, acquire, by the vehicle-mounted camera in the traveling process of the vehicle, the information required for self-calibration of the vehicle-mounted camera.

In one possible implementation, the information includes lane lines on the vehicle traveling road, and the information acquisition module 20 includes: a third information acquisition sub-module, configured to, if the vehicle-mounted camera captures the lane lines on the vehicle traveling road, acquire, by the vehicle-mounted camera in the traveling process of the vehicle, the information required for self-calibration of the vehicle-mounted camera.

In one possible implementation, the information acquisition module 20 includes: a fourth information acquisition sub-module, configured to, if the vehicle-mounted camera captures a horizon line on the vehicle traveling road or a vanishing point of the lane lines, acquire, by the vehicle-mounted camera in the traveling process of the vehicle, the information required for self-calibration of the vehicle-mounted camera.

In one possible implementation, the information acquisition module 20 includes: a fifth information acquisition sub-module, configured to acquire, by the vehicle-mounted camera in the traveling process of the vehicle, the information required for self-calibration of the vehicle-mounted camera within an acquisition duration range.

In one possible implementation, the information acquisition module 20 includes: sixth information acquisition sub-module, configured to acquire, by the vehicle-mounted camera in the traveling process of the vehicle, the information required for self-calibration of the vehicle-mounted camera if a traveling distance of the vehicle falls within a traveling distance range.

In one possible implementation, the self-calibration operation module 30 includes: a homography matrix updating sub-module, configured to update a homography matrix of the vehicle-mounted camera according to the acquired information, the homography matrix of the vehicle-mounted camera reflecting the pose of the vehicle-mounted camera; and a second self-calibration operation sub-module, configured to self-calibrate the vehicle-mounted camera based on the homography matrices of the vehicle-mounted camera before and after the update. The vehicle-mounted camera is self-calibrated by updating the homography matrix of the vehicle-mounted camera, and according to the homography matrices of the vehicle-mounted camera before and after the update. By using the homography matrix of the vehicle-mounted camera, the vehicle-mounted camera is self-calibrated accurately and quickly.

In one possible implementation, the information includes lane lines on the vehicle traveling road, and the homography matrix updating sub-module includes: a lane line detected position information acquisition unit, configured to detect the lane lines in an image captured by the vehicle-mounted camera to obtain detected position information of the lane lines; and a homography matrix updating unit, configured to update the homography matrix of the vehicle-mounted camera according to the detected position information of the lane lines.

In one possible implementation, the second self-calibration operation sub-module includes: a lane line known position information acquisition unit, configured to obtain known position information of the lane lines according to the homography matrix of the vehicle-mounted camera before the update; a calibration parameter acquisition unit, configured to determine a calibration parameter of the vehicle-mounted camera according to the detected position information of the lane lines and the known position information of the lane lines; and a self-calibrating unit, configured to self-calibrate the vehicle-mounted camera based on the calibration parameter.

In one possible implementation, the lane line detected position information acquisition unit is configured to: detect the lane lines in the image captured by the vehicle-mounted camera; and determine key points on the detected lane lines to obtain detected coordinates of the key points; and the calibration parameter acquisition unit is configured to: determine the calibration parameter of the vehicle-mounted camera according to the detected coordinates of the key points and known coordinates of the key points. In the present embodiment, the calibration parameter of the vehicle-mounted camera is obtained according to the detected position information and the known position information of the lane lines, and the vehicle-mounted camera is self-calibrated according to the calibration parameter. The vehicle-mounted camera is self-calibrated according to the calibration parameter, so that the vehicle-mounted camera is able to conveniently complete self-calibration, the calibration efficiency is high, and the embodiments have a wide application range.

In one possible implementation, lane line detected position information acquisition unit is configured to: perform lane line detection in images captured by the vehicle-mounted camera to obtain lane lines to be fitted in the images; and fit the lane lines to be fitted in the images to obtain the lane lines and the detected position information of the lane lines.

In one possible implementation, the lane lines includes a first lane line and a second lane line, and determining key points on the detected lane lines to obtain detected coordinates of the key points includes: determining points of intersection between the first lane lines and the second lane lines in the images according to the detected first lane lines and the detected second lane lines in the images; determining horizon lines according to the points of intersection in the images; and determining key points according to the horizon lines, the first lane lines, and the second lane lines to obtain detected coordinates of the key points.

In one possible implementation, determining key points according to the horizon lines, the first lane lines, and the second lane lines to obtain detected coordinates of the key points includes: determining detection lines parallel with the horizon lines and separately intersecting the first lane lines and the second lane lines; and determining cross points between the detection lines and the first lane lines, and cross points between the detection lines and the second lane lines as the key points to obtain the detected coordinates of the key points.

In one possible implementation, determining the calibration parameter of the vehicle-mounted camera according to the detected coordinates of the key points and known coordinates of the key points includes: determining a conversion parameter of the camera according to the detected coordinates of the key points and the known coordinates of the key points, the detected coordinates of the key points including coordinates of the key points in a driving photographing angle of view, and the known coordinates of the key points including coordinates of the key points in a known angle of view; and determining the calibration parameter of the camera according to the conversion parameter and a known parameter.

In one possible implementation, the known coordinates of the key points include: first known coordinates of the key points in an image coordinate system in the known angle of view, and second known coordinates of the key points in a world coordinate system in the known angle of view; and determining the calibration parameter of the camera according to the conversion parameter and a known parameter includes: determining the known parameter according to the first known coordinates and the second known coordinates; and determining the calibration parameter of the camera according to the conversion parameter and the known parameter.

In one possible implementation, the apparatus further includes: a correcting module, configured to correct the calibration parameter using a perspective principle or a triangle principle according to a correction parameter of the vehicle-mounted camera.

In one possible implementation, the vehicle may include one or any combination of the following devices: a motor vehicle, a non-motor vehicle, a train, a toy car, or a robot.

For the working process and the setting mode of any embodiment of the vehicle-mounted camera self-calibration apparatus provided by the present disclosure, reference may be made to the specific descriptions of the corresponding method embodiments of the present disclosure, and details are not described herein again due to space limitation.

The embodiments of the present disclosure further provide a computer readable storage medium, having computer program instructions stored thereon, where when the computer program instructions are executed by the processor, any one of the method embodiments above is implemented. The computer-readable storage medium may be a nonvolatile computer-readable storage medium or a volatile computer-readable storage medium.

Embodiments of the present disclosure further provide an electronic device, including: a processor and a memory configured to store processor-executable instructions; where the processor executes the method according to any one of the method embodiments above by calling the executable instructions. Reference may be made to the specific descriptions of the corresponding method embodiments of the present disclosure, and details are not described herein again due to space limitation.

FIG. 9 is a block diagram illustrating an electronic device according to exemplary embodiments of the present disclosure. The electronic device may be provided as a terminal, a server, or devices in other forms. For example, the electronic device may include a vehicle-mounted camera self-calibration apparatus, and the vehicle-mounted camera self-calibration apparatus 800 may be a terminal such as a mobile phone, a computer, a digital broadcast terminal, a message transceiving device, a game console, a tablet device, a medical device, exercise equipment, and a personal digital assistant.

With reference to FIG. 9, the apparatus 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the apparatus 800, such as operations associated with display, phone calls, data communications, camera operations, and recording operations. The processing component 802 may include one or more processors 820 to execute instructions to implement all or some of the steps of the methods above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the apparatus 800. Examples of the data include instructions for any application or method operated on the apparatus 800, contact data, contact list data, messages, pictures, videos, and the like. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power supply component 806 provides power for various components of the apparatus 800. The power supply component 806 may include a power management system, one or more power supplies, and other components associated with power generation, management, and distribution for the apparatus 800.

The multimedia component 808 includes a screen between the apparatus 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the apparatus 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the apparatus 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor assembly 814 includes one or more sensors for providing state assessment in various aspects for the apparatus 800. For example, the sensor component 814 may detect an on/off state of the apparatus 800, and relative positioning of components, which are for example the display and keypad of the apparatus 800, and the sensor assembly 814 may further detect a position change of the apparatus 800 or a component of the apparatus 800, the presence or absence of contact of the user with the apparatus 800, the orientation or acceleration/deceleration of the apparatus 800, and a temperature change of the apparatus 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the apparatus 800 and other devices. The apparatus 800 may access a wireless network based on a communication standard, such as WiFi, 2G, or 3G, or a combination thereof. In one exemplary embodiment, the communication component 816 receives a broadcast signal or broadcast-related information from an external broadcast management system by means of a broadcast channel. In one exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In exemplary embodiments, the apparatus 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In exemplary embodiments, a non-volatile computer readable storage medium is further provided, for example, a memory 804 including computer program instructions, which may be executed by the processor 820 of the apparatus 800 to implement the method above.

The flowcharts and block diagrams in the accompanying drawings illustrate the architecture, functionality and operations of possible implementations of systems, methods, and computer program products according to multiple embodiments of the present disclosure. In this regard, each block in the flowchart or block diagram may represent a module, program segment, or portion of instruction, which includes one or more executable instructions for executing the specified logical function. In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, may be implemented by special purpose hardware-based systems that perform the specified functions or actions or implemented by combinations of special purpose hardware and computer instructions.

The descriptions of the embodiments of the present disclosure have been presented for purposes of illustration, but are not intended to be exhaustive or limited to the embodiments disclosed. Many modifications and variations will be apparent to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

What is claimed is:

1. A vehicle-mounted camera self-calibration method, comprising:
starting self-calibration of a vehicle-mounted camera to enable a vehicle on which the vehicle-mounted camera is mounted to be in a traveling state;
acquiring, by the vehicle-mounted camera in a traveling process of the vehicle, information required for self-calibration of the vehicle-mounted camera; and
self-calibrating the vehicle-mounted camera based on the acquired information.

2. The method according to claim 1, wherein starting self-calibration of the vehicle-mounted camera comprises at least one of:
if it is detected that an angle of view or a focal length of the vehicle-mounted camera changes, starting the self-calibration of the vehicle-mounted camera;
if it is detected that a mounting position and/or a photographing angle of the vehicle-mounted camera changes, starting the self-calibration of the vehicle-mounted camera;
determining an accumulated mileage of the vehicle on which the vehicle-mounted camera is mounted, and
if the accumulated mileage is greater than a mileage threshold, starting the self-calibration of the vehicle-mounted camera; and
starting the self-calibration of the vehicle-mounted camera according to a self-calibration start instruction.

3-5. (canceled)

6. The method according to claim 1, further comprising:
providing acquisition progress information, the acquisition progress information comprising progress information of the vehicle-mounted camera in acquisition of the information required for self-calibration,
wherein self-calibrating the vehicle-mounted camera based on the acquired information comprises:
if it is determined according to the acquisition progress information that the acquisition of the information required for self-calibration is completed, self-calibrating the vehicle-mounted camera based on the acquired information.

7. The method according to claim 1, further comprising:
providing acquisition condition prompting information, the acquisition condition prompting information comprising prompting information about whether the vehicle-mounted camera satisfies an acquisition condition, and the acquisition condition comprising a condition under which the vehicle-mounted camera acquires the information required for self-calibration,
wherein acquiring, by the vehicle-mounted camera in a traveling process of the vehicle, information required for self-calibration of the vehicle-mounted camera comprises:
if it is determined according to the acquisition condition prompting information that the vehicle-mounted camera satisfies the acquisition condition, acquiring, by the vehicle-mounted camera in the traveling process of the vehicle, the information required for self-calibration of the vehicle-mounted camera.

8. The method according to claim 1, wherein acquiring, by the vehicle-mounted camera in the traveling process of the vehicle, information required for self-calibration of the vehicle-mounted camera comprises:
if the lens pitch angle of the vehicle-mounted camera falls within a photographing pitch angle range, acquiring, by the vehicle-mounted camera in the traveling process of the vehicle, the information required for self-calibration of the vehicle-mounted camera.

9. The method according to claim 1, wherein the information comprises lane lines on the vehicle traveling road, and acquiring, by the vehicle-mounted camera in the traveling process of the vehicle, information required for self-calibration of the vehicle-mounted camera comprises:
if the vehicle-mounted camera captures the lane lines on the vehicle traveling road, acquiring, by the vehicle-mounted camera in the traveling process of the vehicle, the information required for self-calibration of the vehicle-mounted camera.

10. The method according to claim 9, wherein acquiring, by the vehicle-mounted camera in the traveling process of the vehicle, information required for self-calibration of the vehicle-mounted camera comprises:
if the vehicle-mounted camera captures a horizon line on the vehicle traveling road or a vanishing point of the lane lines, acquiring, by the vehicle-mounted camera in the traveling process of the vehicle, the information required for self-calibration of the vehicle-mounted camera.

11. The method according to claim 1, wherein acquiring, by the vehicle-mounted camera in the traveling process of the vehicle, information required for self-calibration of the vehicle-mounted camera comprises at least one of:
acquiring, by the vehicle-mounted camera in the traveling process of the vehicle, the information required for self-calibration of the vehicle-mounted camera within an acquisition duration range; and
acquiring, by the vehicle-mounted camera in the traveling process of the vehicle, the information required for self-calibration of the vehicle-mounted camera if a traveling distance of the vehicle falls within a traveling distance range.

12. (canceled)

13. The method according to claim 1, wherein self-calibrating the vehicle-mounted camera based on the acquired information comprises:
updating a homography matrix of the vehicle-mounted camera according to the acquired information, the homography matrix of the vehicle-mounted camera reflecting the pose of the vehicle-mounted camera; and
self-calibrating the vehicle-mounted camera based on the homography matrices of the vehicle-mounted camera before and after the update.

14. The method according to claim 13, wherein the information comprises the lane lines on the vehicle traveling road, and updating the homography matrix of the vehicle-mounted camera according to the acquired information comprises:
detecting the lane lines in an image captured by the vehicle-mounted camera to obtain detected position information of the lane lines; and
updating the homography matrix of the vehicle-mounted camera according to the detected position information of the lane lines.

15. The method according to claim 14, wherein self-calibrating the vehicle-mounted camera based on the homography matrices of the vehicle-mounted camera before and after the update comprises:
obtaining known position information of the lane lines according to the homography matrix of the vehicle-mounted camera before the update;
determining a calibration parameter of the vehicle-mounted camera according to the detected position information of the lane lines and the known position information of the lane lines; and
self-calibrating the vehicle-mounted camera based on the calibration parameter.

16. The method according to claim 15, wherein detecting the lane lines in the image captured by the vehicle-mounted camera to obtain detected position information of the lane lines comprises:
detecting the lane lines in the image captured by the vehicle-mounted camera; and
determining key points on the detected lane lines to obtain detected coordinates of the key points; and
determining the calibration parameter of the vehicle-mounted camera according to the detected position information of the lane lines and the known position information of the lane lines comprises:
determining the calibration parameter of the vehicle-mounted camera according to the detected coordinates of the key points and known coordinates of the key points.

17. The method according to claim 14, wherein detecting the lane lines in the image captured by the vehicle-mounted camera to obtain detected position information of the lane lines comprises:
performing lane line detection in images captured by the vehicle-mounted camera to obtain lane lines to be fitted in the images; and
fitting the lane lines to be fitted in the images to obtain the lane lines and the detected position information of the lane lines.

18. The method according to claim 16, wherein the lane lines comprise a first lane line and a second lane line, and determining key points on the detected lane lines to obtain detected coordinates of the key points comprises:
determining points of intersection between the first lane lines and the second lane lines in the images according to the detected first lane lines and the detected second lane lines in the images;
determining horizon lines according to the points of intersection in the images; and
determining key points according to the horizon lines, the first lane lines, and the second lane lines to obtain detected coordinates of the key points.

19. The method according to claim 18, wherein determining key points according to the horizon lines, the first lane lines, and the second lane lines to obtain detected coordinates of the key points comprises:
determining detection lines parallel with the horizon lines and separately intersecting the first lane lines and the second lane lines; and
determining cross points between the detection lines and the first lane lines, and cross points between the detection lines and the second lane lines as the key points to obtain the detected coordinates of the key points.

20. The method according to claim 16, wherein determining the calibration parameter of the vehicle-mounted camera according to the detected coordinates of the key points and know coordinates of the key points comprises:
determining a conversion parameter of the camera according to the detected coordinates of the key points and the known coordinates of the key points, the detected coordinates of the key points comprising coordinates of the key points in a driving photographing angle of view, and the known coordinates of the key points comprising coordinates of the key points in a known angle of view; and
determining the calibration parameter of the camera according to the conversion parameter and a known parameter.

21. The method according to claim 20, wherein the known coordinates of the key points comprise:
first known coordinates of the key points in an image coordinate system in the known angle of view, and
second known coordinates of the key points in a world coordinate system in the known angle of view; and
determining the calibration parameter of the camera according to the conversion parameter and the known parameter comprises:
determining the known parameter according to the first known coordinates and the second known coordinates; and
determining the calibration parameter of the camera according to the conversion parameter and the known parameter.

22. The method according to claim 15, further comprising:
correcting the calibration parameter using a perspective principle or a triangle principle according to a correction parameter of the vehicle-mounted camera.

23-48. (canceled)

49. An electronic device, comprising:
a processor; and
a memory configured to store processor-executable instructions;
wherein the processor is configured to invoke the instructions stored in the memory, so as to:
start self-calibration of a vehicle-mounted camera to enable a vehicle on which the vehicle-mounted camera is mounted to be in a traveling state;
acquire, by the vehicle-mounted camera in a traveling process of the vehicle, information required for self-calibration of the vehicle-mounted camera; and
self-calibrate the vehicle-mounted camera based on the acquired information.

50. A non-transitory computer readable storage medium, having computer program instructions stored thereon, wherein when the computer program instructions are executed by a processor, the processor is caused to perform the operations of:
starting self-calibration of a vehicle-mounted camera to enable a vehicle on which the vehicle-mounted camera is mounted to be in a traveling state;
acquiring, by the vehicle-mounted camera in a traveling process of the vehicle, information required for self-calibration of the vehicle-mounted camera; and
self-calibrating the vehicle-mounted camera based on the acquired information.

51. (canceled)
